(19) United States
(12) Patent Application Publication
(10) Pub. No.: US 2022/0180751 A1
(43) Pub. Date: Jun. 9, 2022

(54) REDUCING LATENCY IN INTELLIGENT RURAL ROADWAYS

(71) Applicant: INTERNATIONAL BUSINESS MACHINES CORPORATION, Armonk, NY (US)

(72) Inventors: John Melchionne, Kingston, NY (US); John Behnken, Hurley, NY (US); Michael Amisano, East Northport, NY (US); Jeb R. Linton, Manassas, VA (US); David K. Wright, Monroe, MI (US); Dennis Kramer, Siler City, NC (US)

(21) Appl. No.: 17/110,378

(22) Filed: Dec. 3, 2020

(51) Int. Cl. G08G 1/00; G08G 1/0967; G08G 1/09

(52) U.S. Cl. CPC G08G 1/20; G08G 1/096741; G08G 1/093; G08G 1/096716

(57) ABSTRACT

A method, a computer program product and a computer system update and share relevant event information among vehicles. The method includes acquiring event information by a device having a sensor. The method also includes classifying the event information as relevant to a vehicle. The method further includes the device transmitting the event information classified as relevant to a first intermediate storage device within a range of the first intermediate storage device. In addition, the method includes the first intermediate storage device transmitting the received event information to a node in a network. The network includes at least one other vehicle within a range of the first intermediate storage device and one or more other intermediate storage devices. Lastly, the method includes a vehicle receiving the event information classified as relevant and modifying the operation of the vehicle.

### FIELD

Embodiments relate, generally, to the field of autonomous and/or semi-autonomous vehicles, and more specifically to acquiring relevant event information from autonomous and/or semi-autonomous vehicles and transmitting the relevant event information to other autonomous and/or semi-autonomous vehicles via intelligent data buoys.

### BACKGROUND

Motor vehicles are steadily becoming more automated in order to reduce distractions while driving and to provide other safety features. Vehicles equipped with various automated driver assistance features are able to drive themselves in varying degrees through private and/or public spaces while being monitored by a human driver. Using a system of sensors that detect the location and/or surroundings of the vehicle, logic within or associated with the vehicle may control the speed, propulsion, braking, and steering of the vehicle based on the sensor-detected location and surroundings of the vehicle.

### SUMMARY

An embodiment is directed to a computer-implemented method for updating and sharing relevant event information among vehicles. The method may include acquiring event information by a device having a sensor. The method may also include classifying the event information as relevant to a vehicle. In addition, the method may include the device transmitting the event information classified as relevant to a first intermediate storage device within a range of the first intermediate storage device. The method may further include the first intermediate storage device transmitting the received event information to a node in a network. The network may include at least one other vehicle within a range of the first intermediate storage device and one or more other intermediate storage devices. Lastly, the method may include a vehicle receiving the event information classified as relevant and modifying the operation of the vehicle in response to the receiving of the event information classified as relevant.

In addition to a computer-implemented method, additional embodiments are directed to a system and a computer program product for updating and sharing relevant event information among vehicles.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 depicts a block diagram of an example system for acquiring from and providing to vehicles relevant event information in accordance with various embodiments.

FIG. 2 depicts a flowchart of a method for updating and sharing relevant event information between intelligent data buoys and vehicles according to an embodiment.

FIG. 3 depicts a block diagram of internal and external components of the intelligent data buoys and other network devices depicted in FIG. 1 according to at least one embodiment.

FIG. 4 depicts a cloud computing environment according to an embodiment of the present invention.

FIG. 5 depicts abstraction model layers according to an embodiment of the present invention.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

As autonomous and semi-autonomous vehicles become more prevalent, the data that they collect with their large array of on-board sensors for analyzing their surroundings becomes more valuable as a real-time snapshot of road conditions for informing all vehicles. In urban areas, where wireless connectivity is more or less constant, this data may be updated and shared among vehicles easily and quickly. However, in more rural areas where one may go for many miles without connectivity or severely limited connectivity, it is a challenge to communicate updates between vehicles. There is a need to provide a low-latency communication link to vehicles so that they have up to date information about road conditions and relevant events. The exemplary embodiments are directed to a system and method for reducing latency in intelligent rural roadways by deploying a distributed wireless mesh relay of intelligent data buoys. These intelligent data buoys may communicate with vehicles and store the data received to transmit to vehicles that follow on the road. The intelligent data buoys may also communicate via a wireless link to each other and to a central server as needed.

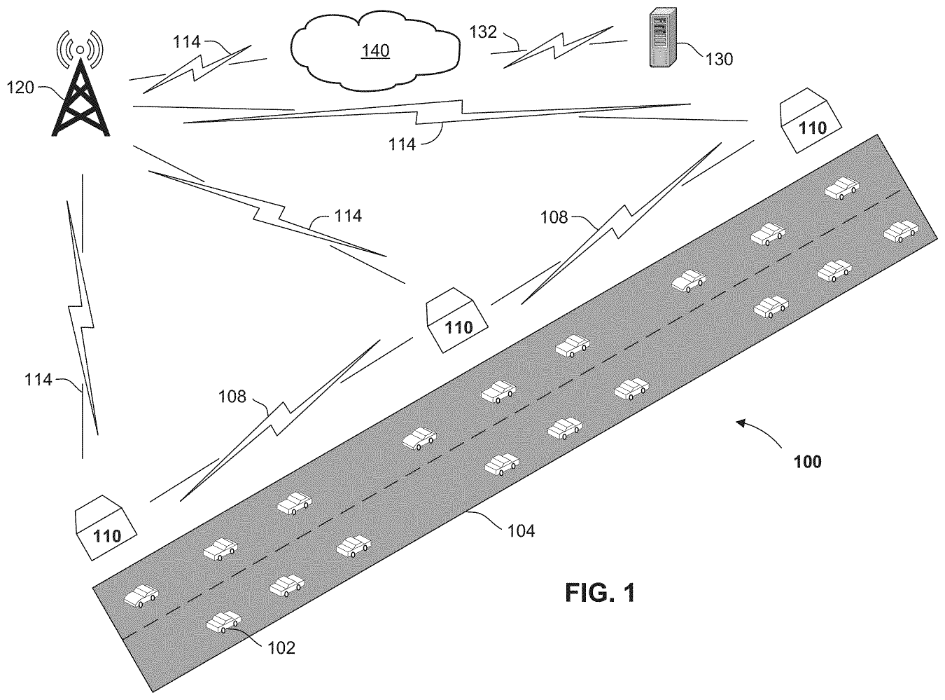

Referring now to FIG. 1, a block diagram is depicted of an example system 100 for communicating relevant event information to and from conventional, autonomous, and/or semi-autonomous vehicles in accordance with various embodiments. While the shown vehicles are automobiles, any vehicle is contemplated, e.g., truck, motorcycle, boat, ship, or bicycle. In addition, a person traveling by foot is also contemplated. Intelligent data buoys 110, also referred to herein as “intermediate storage devices”, may be deployed to a plurality of roadways 104, which may include roads, intersections, bridges, railways, rail crossings, etc. Roadways 104 may also include waterways in the context of ship and boat travel and also may include trails in the context of hiking and off-road bicycling. In an embodiment, the intelligent data buoys 110 may be attached to items near the roadway 104, e.g., streetlights, traffic lights, toll booths, guard rails or mile markers. Each of the intelligent data buoys 110 may include one or more short range radio transceivers to receive, from the one or more vehicles 102, relevant event information. The relevant event information may include information about the roadways 104 and the one or more vehicles 102 traveling thereon. Included in the calculation of relevance is a time sensitivity element. As an example, an update about an obstruction in the roadway 104 may only be useful to vehicles 102 in the proximate area and only for a limited time. This time sensitivity may determine how quickly an intelligent data buoy 110 forwards information to other nodes in the network, which include vehicles 102, intelligent data buoys 110, cellular tower 120 (or satellite) and central server 130. Moreover, each of the intelligent data buoys 110 may include one or more long range radio transceivers to transmit the relevant event information to other intelligent data buoys 110 or, at the same time or alternatively, to a central server 130 via a wireless link 108 or 114. In an embodiment, intelligent data buoys 110 may be deployed on the one or more vehicles 102. In this embodiment, the intelligent data buoy 110 would communicate directly with the vehicle on-board sensors and use the wireless network interface to communicate with other intelligent data buoys 110 or a central server 130.

It should be noted that the range of transmission between nodes in the network, i.e., the ranges for wireless links 108 or 114 in FIG. 1, as well as the range between a particular vehicle 102 and particular intelligent data buoy 110, is limited based on the technology used for the transmission. For example, vehicle to vehicle, or V2V, communication technologies and transmissions in the millimeter-wave frequency band (assigned to 5G wireless, the next generation low-latency, high-bandwidth standard) have a range of about 300 meters or 1000 feet. This limited range may require, in some embodiments, that the density of intelligent data buoys 110 that are deployed in the field be increased and a topology in which many intelligent data buoys 110 are connected to one another, and only one of a given batch of data buoys has responsibility of communicating with a cellular tower 120 or satellite. In other words, while each of the data buoys 110 depicted in FIG. 1 is shown having a link 114 to cell tower 120, in other embodiments, one or more instances of intelligent data buoy 110 may not have a link 114 to cell tower 120. In various embodiments, a particular intelligent data buoy 110 may be “off grid,” or “disconnected” from all but one other node in a mesh network, i.e., out of range of a cell tower and all other intelligent data buoys 110 except one other intelligent data buoy 110. In addition, a particular intelligent data buoy 110 may only have a communication range that is line of sight, or that is between 20 meters and 1.6 kilometers.

One or more cellular towers 120 may be connected, directly or indirectly, to the distributed intelligent data buoys 110 and to an IP network 140 via one or more wireless links 108. The central server 130 may be connected to the network of intelligent data buoys 110 through the IP network 140 via a network link 132. In addition or alternatively, the one or more cellular towers 120 may be connected to the distributed intelligent data buoys 110 and the central server 130 through the IP network 140 via one or more satellite networks, microwave radio networks, wired networks, fiber optic networks, etc. The communication network may be any type of network configured to provide for voice, data, or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as single links, a network can include any number of interconnected elements or links.

The interconnected intelligent data buoys 110 may be configured as a mesh (or ad-hoc) network. Mesh network refers to a networking topology where the nodes, e.g, the intelligent data buoys 110, may connect directly and dynamically with no hierarchical structure in order to communicate with as many other nodes as possible and also cooperate to efficiently route data through the network. In this embodiment, the operations and processing that would otherwise be performed by a central server 130 or operations center (not depicted) are instead performed by each of the intelligent data buoys 110 of the network. The data that is gathered and processed by each of the intelligent data buoys 110 may be automatically shared among the other intelligent data buoys 110. In this way, the relevant event information may be obtained and processed by the network itself and the network of interconnected intelligent data buoys 110 may also share the relevant event information with other vehicles without the need for cellular towers 120 or a central server 130. In a further embodiment, there may be several intelligent data buoys 110 deployed on a stretch of rural roadway or mountain biking trail 104 such that only a portion of the intelligent data buoys 110 may communicate with a cellular tower 120 or satellite. In this embodiment, the intelligent data buoys 110 may be positioned such that they pass data between them until reaching one of the intelligent data buoys 110 with enhanced communication capability, at which point the data may pass to a cellular tower 120 or satellite and the network.

The one or more vehicles 102 may include an autonomous vehicle and/or a semi-autonomous vehicle. However, it is not required that a vehicle 102 be autonomous or semi-autonomous. The vehicle 102 may be an automobile for primarily transporting people. In addition, the vehicle may be other suitable types of vehicles for transporting goods, people, or any combination thereof. For example, the vehicle may be a car, truck, train, etc. An autonomous vehicle incorporates artificial intelligence in the sense that an autonomous vehicle may automatically navigate and operate the vehicle itself with little or no assistance from a human driver. A semi-autonomous vehicle also incorporates artificial intelligence, but to a lesser degree than the autonomous vehicle. This means that a semi-autonomous vehicle may require some assistance or operational control from a human driver. When referring to a “vehicle” or “vehicles” herein, such vehicle or vehicles can be autonomous, semi-autonomous, or any combination thereof.

A vehicle 102 may also include one or more on-vehicle navigation and control sensors, for example a speed sensor, a wheel speed sensor, a camera, a gyroscope, an optical sensor, a laser sensor, a radar sensor, a sonic sensor, or any other sensor or device or combination thereof that is capable of determining or identifying relevant events related to the vehicle or roadway. Navigation and control sensors may include hardware sensors that determine the location of the vehicle 102, sense other cars and/or obstacles and/or physical structures around the vehicle 102, measure the speed and direction of the vehicle 102 and provide any other inputs needed to safely control the movement of the vehicle 102.

With respect to the feature of determining the location of the vehicle 102, this can be achieved through the use of a positioning system such as a global positioning system (GPS), which uses space-based satellites that provide positioning signals that are triangulated by a GPS receiver to determine a 3-D geophysical position of the vehicle 102. The positioning system may also use, either alone or in conjunction with a GPS system, physical movement sensors such as accelerometers (which measure rates of changes to a vehicle in any direction), speedometers (which measure the instantaneous speed of a vehicle), airflow meters (which measure the flow of air around a vehicle), etc. Such physical movement sensors may incorporate the use of semiconductor strain gauges, electromechanical gauges that take readings from drivetrain rotations, barometric sensors, etc.

With respect to the feature of sensing other cars and/or obstacles and/or physical structures around the vehicle 102, the positioning system may use radar or other electromagnetic energy that is emitted from an electromagnetic radiation transmitter, bounced off a physical structure (e.g., another car), and then received by an electromagnetic radiation receiver. By measuring the time it takes to receive back the emitted electromagnetic radiation, and/or evaluating a Doppler shift (i.e., a change in frequency to the electromagnetic radiation that is caused by the relative movement of the vehicle 102 to objects being interrogated by the electromagnetic radiation) in the received electromagnetic radiation from when it was transmitted, the presence and location of other physical objects can be ascertained by the vehicle 102.

With respect to the feature of measuring the speed and direction of the vehicle 102, this can be accomplished by taking readings from an on-board speedometer (not depicted) on the vehicle 102 and/or detecting movements to the steering mechanism (also not depicted) on the vehicle 102 and/or the positioning system discussed above. In addition, control signals transmitted to a vehicle's propulsion and braking systems may be monitored to determine acceleration or deceleration of the vehicle.

With respect to the feature of providing any other inputs needed to safely control the movement of the vehicle 102, such inputs include, but are not limited to, control signals to activate a horn, turning indicators, flashing emergency lights, airbags, etc. on the vehicle 102.

In one or more embodiments of the present invention, vehicle 102 or intelligent data buoy 110 includes roadway sensors that may be coupled to the vehicle 102 or integrated with the intelligent data buoy 110. Roadway sensors may include sensors that are able to detect the amount of water, snow or ice on the roadway (e.g., using cameras, heat sensors, moisture sensors, thermometers, etc.). Roadway sensors also include sensors that may detect “rough” roadways (e.g., roadways having potholes, poorly maintained pavement, no paving, etc.) using cameras, vibration sensors, etc. Roadway sensors may also include sensors that are also able to detect how dark the roadway 104 is using light sensors. The vehicle 102 may traverse one or more roadways using information communicated via the network of intelligent data buoys 110, such as the relevant event information, information identified by one or more of its on-vehicle sensors, or a combination thereof.

Although the vehicle 102 is depicted communicating with the intelligent data buoy via a wireless communication link 108, the vehicle 102 may communicate via any number of direct or indirect communication links. In some embodiments, a wireless communication link 108 may include an Ethernet link, a serial link, a Bluetooth link, an infrared (IR) link, an ultraviolet (UV) link, or any link capable of providing electronic communication. For example, the vehicle 102 may communicate with the intelligent data buoy 110 or other vehicles 102 via a direct communication link, such as a Bluetooth communication link. In another embodiment, the transmission of relevant event information may be using “Light Fidelity” (LiFi) as a mechanism to enhance the signal in locations with painted roadways, though use of LiFi is not limited to locations with painted roadways. It should be noted that for simplicity, FIG. 1 depicts one set of intelligent data buoys 110 and communication networks 100 but in various embodiments, any number of networks or communication devices may be used. The communication between the intelligent data buoy 110 and vehicle 102 may account for vehicle speed in determining the urgency and speed of the communication. For instance, a vehicle may transmit a data packet to an intelligent data buoy 110 requesting any relevant data that the intelligent data buoy 110 may have. This packet may include the current speed of the vehicle. If this speed is relatively slow, e.g., 30 miles per hour (30 mph), then the intelligent data buoy 110 may determine that it has relatively more time to deliver any relevant information to other vehicles or intelligent data buoys 110 than if this speed were relatively fast, e.g., 70 mph. Accordingly, if an intelligent data buoy 110 has a queue of requests for data, it may rank requests according to vehicle speed. If the intelligent data buoy 110 is on board a vehicle, the speed of the host vehicle 102 may be accounted for. As an example, a first vehicle 102 traveling 65 mph in a first direction may receive a data request from a second vehicle 102 traveling in the same direction at 70 mph. The second vehicle 102 is 60 feet behind the first vehicle 102 and will be in transmission range for on the order of 20-30 seconds. A short time after the request from the second vehicle 102, the first vehicle 102 receives a request from a third vehicle 102 traveling in the opposite direction at 60 mph. The third vehicle 102 is 40 feet in front the first vehicle in the opposite lane. The third vehicle 102 will be in transmission range for on the order of 5-10 seconds. In this example, the request from the third vehicle 102 is ranked higher than the request from the second vehicle 102 because the time window when the third vehicle 102 is in transmission range is smaller than the time window that the second vehicle 102 will be within range. In addition, if an intelligent data buoy 110 has a queue of requests for data, the relevance of the data it provides may be taken into account in ranking requests. For example, assume that the information that is to be transmitted to the second vehicle 102 in the above example is of high relevance, especially where relevance may relate to safety or timeliness, for example, an obstruction in the roadway that requires a course change maneuver. In addition, assume that the information that is to be transmitted to the third vehicle 102 in the above example is of low relevance, e.g., moderate congestion a mile ahead. In this example, the request from the second vehicle 102 would be ranked higher than the request from the third vehicle 102 because the data to be transmitted to the second vehicle 102 is more relevant than the data transmitted to the third vehicle 102.

To enhance security of the transmission and ensure the validity of incoming events, trusted computing principles may be followed in the communication between nodes in the network, e.g., intelligent data buoys 110 and vehicles 102, as well as cellular tower 120 (or satellite) or central server 130. Accepted trusted computing principles include endorsement keys (use of public and private encryption key pairs), secure input and output, memory curtaining (or isolation of sensitive areas of memory), sealed storage, remote attestation (allowing authorized users to detect changes to a remote computer) and Trusted Third Party (TTP). In an embodiment, distributed ledger technology (DLT), of which blockchain is an example, may be used to secure transmissions and event information between nodes in the network. In this embodiment, the event information may be sent to multiple nodes simultaneously such that the nodes may verify with each other about receiving a given update from a central server 130, vehicle 102, or other intelligent data buoy 110 in addition to verifying the information independently.

Both the vehicle 102 and the intelligent data buoys 110 may also communicate with each other, or between vehicles 102 and intelligent data buoys 110, or with a central server 130, or with any combination thereof via a satellite, which may include a computing device, or other non-terrestrial communication device, e.g., drone or balloon staying aloft for extended periods, e.g., weeks or months, that may be configured appropriately for communication.

FIG. 1 depicts a first vehicle 102, a limited number of other vehicles 102 and the roadway 104. However, any number of vehicles, or computing devices may be used. In some embodiments, the vehicle transportation and communication system may include devices, units, or elements not depicted in FIG. 1. Although the vehicles 102 are depicted as single units, a vehicle may include any number of interconnected elements.

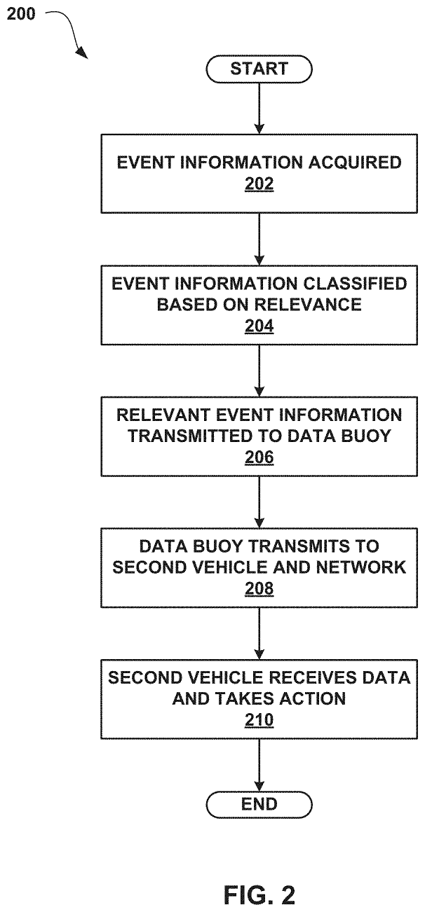

Referring to FIG. 2, an operational flowchart illustrating a process for updating and sharing relevant event information between intelligent data buoys and vehicles 200 is depicted according to at least one embodiment. At 202, a vehicle 102 may detect that an event has occurred via its on-board sensors. For example, the vehicle 102 may detect a road obstruction such as a downed tree or utility pole. Other embodiments include a ship detecting an obstruction in a crowded harbor or shipping channel or a bicycle detecting a fallen tree across an off-road trail. In another embodiment, the vehicle 102 may detect that surrounding vehicles are slowing significantly, and the vehicle may or may not know the cause. In other embodiments, event information may be sent to the vehicle 102 by an intelligent data buoy 110 that has received information from another intelligent data buoy 110 or a central server 130 via a cellular tower 120 or satellite. In further embodiments, an intelligent data buoy 110 may detect an event using its own sensors, and may store or transmit the information, or both store and transmit. The set of events received by the vehicle 102 is the input to the event processor 320 within the vehicle 102 that will be used to determine relevance to other vehicles and the transportation network as a whole.

At 204, the event processor 320 of the vehicle 102 may classify the event as relevant or not relevant based on a machine learning classification model that predicts the relevance of events to course correction, speed change, trip route, and other decisions for other vehicles. A relevant event may include a vehicle crash, lane closure, object on road, disabled vehicle on shoulder, slowdown, icing or wet pavement, gravel on road or shoulder, narrow lanes, or road construction, or any other suitably relevant event. Inputs to systems of an autonomous or semi-autonomous vehicle may classified as relevant, for example, braking, swerving, lane changing, or need for a driver to take control may be classified as relevant. As noted above, there may also be a time sensitivity factor in determining relevance, as updates about current conditions may become stale after some time and it may be most important to transmit information about sudden changes in conditions to other vehicles, not simply information about conditions. As one example, flash flooding of a road may be highly relevant for a period of 1-24 hours after it is first detected, but of much less relevance days or weeks after the condition is first detected. One or more of the following machine learning algorithms may be used to classify the events: logistic regression, naive Bayes, support vector machines, artificial neural networks, random forecasts and random forests. In an embodiment, an ensemble learning technique is employed that uses multiple machine learning algorithms together to assure better prediction when compared with the prediction of a single machine learning algorithm. The training data for the machine learning algorithms may be collected from a single vehicle or group of vehicles. The classification results may be stored in the database 322 so that the data is most current, and the output may always be up to date.

At 206, the vehicle 102 may transmit the event information classified as relevant to any nearby intelligent data buoy 110. For example, the first vehicle may detect an intelligent data buoy 110 on the side of the roadway 104 or another vehicle (serving as an intelligent data buoy 110) that is passing by on the roadway. The vehicle 102 may transmit the updated information via wireless link to the desired receiver. In an embodiment, the intelligent data buoy 110 may be embedded in the vehicle. In this embodiment, the updated information may be uploaded into the intelligent data buoy module in the vehicle and sent to the network of intelligent data buoys 110 in step 208. Transmission of relevant events from the vehicle 102 may be initiated by a human manually or by the machine learning system that classifies the events and is attached to sensors in the vehicle 102.

At 208, the intelligent data buoy 110 that receives the relevant event information may transmit to the network, e.g., other intelligent data buoys 110, vehicles 102 within transmission range, or both other intelligent data buoys 110 and vehicles 102. In addition, at this stage, the intelligent data buoys 110 within the network that have received this information may be configured to forward any updates that they receive to other intelligent data buoys 110 that are within their respective transmission ranges. Any intelligent data buoy 110 that receives the relevant event information may also forward the information to a cellular tower 120 or the central server 130 if the particular intelligent data buoy 110 is within transmission range of these network components. This mesh relaying of relevant event information may include any intelligent data buoy module deployed on a vehicle in that embodiment. It should be noted that relevant events need not be exclusively detected by and received from vehicles. In other embodiments, information generated from a central location connected to central server 130 may also communicate updated relevant events to the intelligent data buoys 110. In yet other embodiments, event information captured by sensors embedded in or deployed with the intelligent data buoy 110 may be communicated to other data buoys and to vehicles.

At 210, responsive to an update being received at a second vehicle 102, the second vehicle 102 may take action based on the update. For example, if the relevant event information includes notification of a road closure, the on-board computer of the second vehicle 102 may access mapping software, either locally or via its wireless link to the Internet, to recommend an alternative route. If the vehicle 102 is being operated by the computer, the vehicle 102 may alter course to route away from a potential obstacle. In a further example, the second vehicle 102 may receive an update that an accident has occurred on the roadway 104. The second vehicle 102 may alert a human driver to take driving control of the vehicle or may slow the vehicle down or change lanes to avoid the accident scene. In some embodiments, a vehicle 102 may receive event information from an intelligent data buoy 110 that has not been classified according to relevance. For example, an environmental condition sensed by a roadside intelligent data buoy 110 may be transmitted to a vehicle 102 without being first classified for relevance. In this case, upon receipt of the unclassified data, the vehicle 102 may classify the event as relevant or not relevant based on a machine learning classification model.

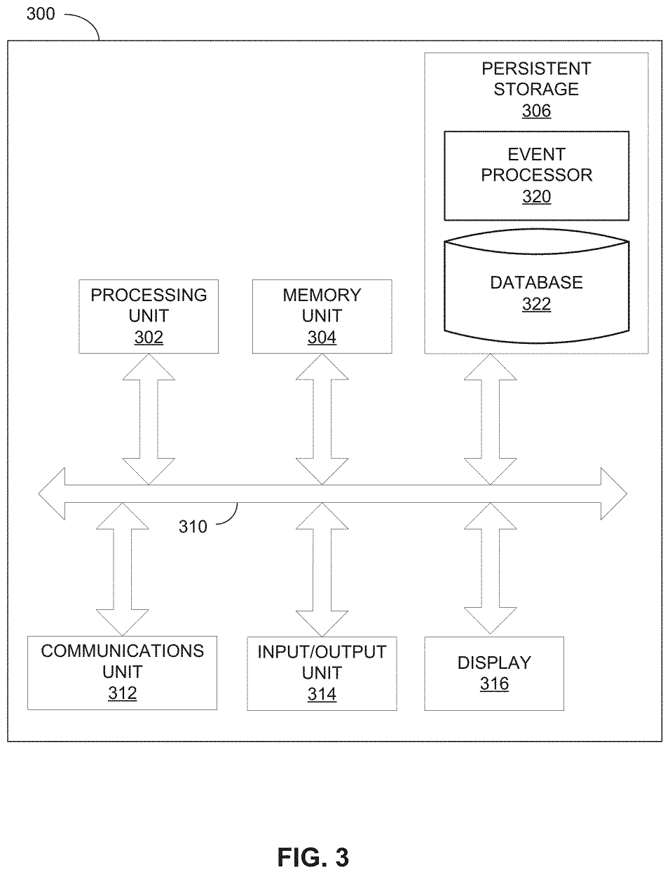

Referring to FIG. 3, a block diagram is shown illustrating a computer system 300 which may be embedded in the vehicle 102 or intelligent data buoy 110 depicted in FIG. 1 in accordance with an embodiment. It should be appreciated that FIG. 3 provides only an illustration of one implementation and does not imply any limitations with regard to the environments in which different embodiments may be implemented. Many modifications to the depicted environments may be made based on design and implementation requirements.

As shown, a computer system 300 includes a processor unit 302, a memory unit 304, a persistent storage 306, a communications unit 312, an input/output unit 314, a display 316, and a system bus 310. Computer programs such as the event processor 320 and database 322 are typically stored in the persistent storage 306 until they are needed for execution, at which time the programs are brought into the memory unit 304 so that they can be directly accessed by the processor unit 302. The event processor 320 may include a machine learning classification model for classifying events according to relevance. The processor unit 302 selects a part of memory unit 304 to read and/or write by using an address that the processor 302 gives to memory 304 along with a request to read and/or write. Usually, the reading and interpretation of an encoded instruction at an address causes the processor 302 to fetch a subsequent instruction, either at a subsequent address or some other address. The processor unit 302, memory unit 304, persistent storage 306, communications unit 312, input/output unit 314, and display 316 interface with each other through the system bus 310. The input/output unit 314 may be communicatively coupled with vehicle sensors and any control system of a conventional, autonomous, or semi-autonomous vehicle. In addition, the input/output unit 314 may be communicatively coupled with a data buoy 110, cell tower 120, or a satellite via an appropriate radio transceiver.

Examples of computing systems, environments, and/or configurations that may be represented by the data processing system 300 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 300 also includes a communications unit 312 such as TCP/IP adapter cards, wireless Wi-Fi interface cards, or 3G or 4G wireless interface cards or other wired or wireless communication links. The network may comprise copper wires, optical fibers, wireless transmission, routers, firewalls, switches, gateway computers and/or edge server, as discussed above with respect to FIG. 1.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

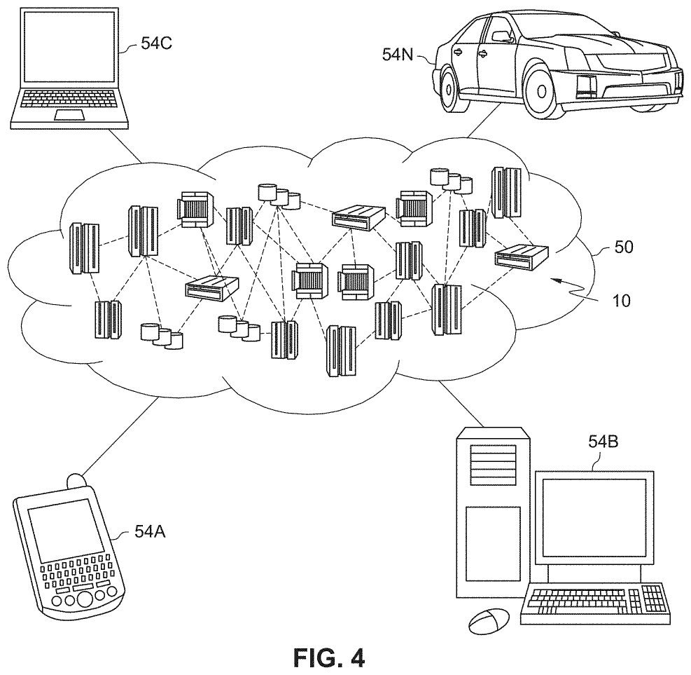

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 610 and cloud computing environment 50 can communicate with any type of computerized device over any type of network and/or network addressable connection (e.g., using a web browser).

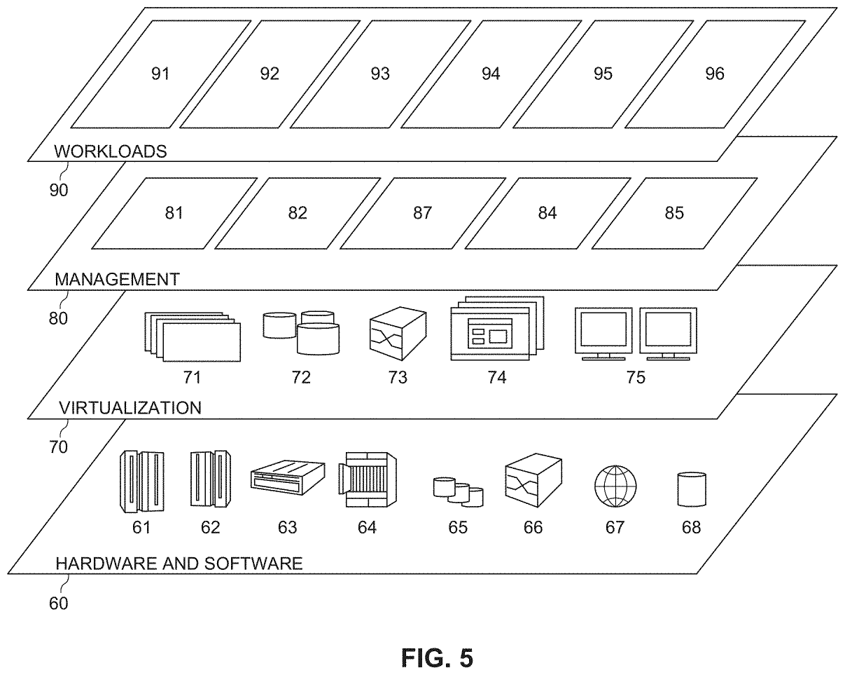

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Internet search recommendation refining 96.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for updating and sharing relevant event information among vehicles, comprising:
acquiring event information by a device having a sensor;
classifying the event information as relevant to a vehicle;
transmitting to a first intermediate storage device within a range of the first intermediate storage device, by the device, the event information classified as relevant;
transmitting to a node in a network, by the first intermediate storage device, the received event information, wherein the network includes at least one other vehicle within a range of the first intermediate storage device, and one or more other intermediate storage devices; and
receiving, by a vehicle, the event information classified as relevant.

2. The computer-implemented method of claim 1, further comprising: modifying the operation of the vehicle in response to the receiving of the event information classified as relevant.

3. The computer-implemented method of claim 1, wherein the first intermediate storage device is installed on a vehicle.

4. The computer-implemented method of claim 1, wherein the first intermediate storage device is installed on one or more of a streetlight or traffic light, a toll booth, bridge, guard rail, and mileage marker.

5. The computer-implemented method of claim 1, wherein the sensor acquiring event information is a vehicle or an intermediate storage device disposed at a fixed location.

6. The computer-implemented method of claim 1, wherein the range of the first intermediate storage device is between 20 meters and 1.6 kilometers.

7. The computer-implemented method of claim 1, wherein the transmitting to a first intermediate storage device by the first vehicle, or the transmitting to a vehicle by the first intermediate storage device is a transmission using modulated light intensity to transmit data.

8. The computer-implemented method of claim 1, wherein the transmitting the event information classified as relevant is transmitted using distributed ledger technology.

9. A computer program product for updating and sharing relevant event information among vehicles, the computer program product comprising:
a computer readable storage device storing computer readable program code embodied therewith, the computer readable program code comprising program code executable by a computer to perform a method comprising:
acquiring event information by a device having a sensor;
classifying the event information as relevant to a vehicle;
transmitting to a first intermediate storage device within a range of the first intermediate storage device, by the device, the event information classified as relevant;
transmitting to a node in a network, by the first intermediate storage device, the received event information, wherein the network includes at least one other vehicle within a range of the first intermediate storage device, and one or more other intermediate storage devices; and
receiving, by a vehicle, the event information classified as relevant.

10. The computer program product of claim 9, further comprising: modifying the operation of the vehicle in response to the receiving of the event information classified as relevant.

11. The computer program product of claim 9, wherein the first intermediate storage device is installed on a vehicle.

12. The computer program product of claim 9, wherein the first intermediate storage device is installed on one or more of a streetlight or traffic light, a toll booth, bridge, guard rail, and mileage marker.

13. computer program product of claim 9, wherein the sensor acquiring event information is a vehicle or an intermediate storage device disposed at a fixed location.

14. The computer program product of claim 9, wherein the range of the first intermediate storage device is between 20 meters and 1.6 kilometers.

15. A computer system for refining Internet search recommendations, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
acquiring event information by a device having a sensor;
classifying the event information as relevant to a vehicle;
transmitting to a first intermediate storage device within a range of the first intermediate storage device, by the device, the event information classified as relevant;
transmitting to a node in a network, by the first intermediate storage device, the received event information, wherein the network includes at least one other vehicle within a range of the first intermediate storage device, and one or more other intermediate storage devices; and
receiving, by a vehicle, the event information classified as relevant.

16. The computer system of claim 15, further comprising: modifying the operation of the vehicle in response to the receiving of the event information classified as relevant.

17. The computer system of claim 15, wherein the first intermediate storage device is installed on a vehicle.

18. The computer system of claim 15, wherein the first intermediate storage device is installed on one or more of a streetlight or traffic light, a toll booth, bridge, guard rail, and mileage marker.

19. The computer system of claim 15, wherein the sensor acquiring event information is a vehicle or an intermediate storage device disposed at a fixed location.

20. The computer system of claim 15, wherein the range of the first intermediate storage device is between 20 meters and 1.6 kilometers.
